(19) United States
(12) Patent Application Publication
(10) Pub. No.: US 2006/0165411 A1
(43) Pub. Date: Jul. 27, 2006

(54) Method for determining the network load in a transparent optical transmission system

(76) Inventor: Paul Schluter, Munich (DE)

Correspondence Address: Siemens Corporation;Intellectual Property Department, 170 Wood Avenue South, Iselin, NJ, 08830, US

(21) Appl. No.: 10/546,441

(22) PCT Filed: Jan. 29, 2004
(86) PCT No.: PCT/EP04/00807

§ 371 Date: Aug. 19, 2005

(30) Foreign Application Priority Data
Feb. 21, 2003 (DE) 10307493.7
Mar. 12, 2003 (DE) 10310798.3

(51) Int. Cl. H04B 10/08

(52) U.S. Cl. 398/33

(57) ABSTRACT

Disclosed is a transparent optical transmission system comprising a plurality of network nodes that are interconnected via optical transmission links. Several optical connection paths in said transparent optical transmission system are established, maintained and disconnected from a first optical network node to a second optical network load by means of signaling messages via at least one transmission link which is provided with optical transmission channels. A probability of occupancy is determined for each optical transmission channel per transmission link in order to improve the network load information in the network nodes.

### CROSS REFERENCE TO RELATED APPLICATIONS

This application is the US National Stage of International Application No. PCT/EP2004/000807, filed Jan. 29, 2004 and claims the benefit thereof. The International Application claims the benefits of German application No. 10307493.7, filed Feb. 21, 2003 and German application No. 10310798.3, filed Mar. 12, 2003, all three of the applications are incorporated by reference wherein in their entirety.

### FIELD OF INVENTION

The invention relates to a method for determining the network load in a transparent optical transmission system with a number of network loads connected to each other by optical transmission links, in which several optical connection paths are established, maintained and disconnected from a first optical network load to a second optical network load by means of signaling messages via at least one transmission link provided with optical transmission channels.

### SUMMARY OF THE INVENTION

In the course of the rapid growth of the Internet, the demands-on the available transmission bandwidth have risen very disproportionately in recent years. Advances in the development of optical transmission systems, particularly transmission systems based on wavelength division multiplexing (WDM), have contributed to a realization of high transmission bandwidths. Transparent optical transmission systems that enable complete transmission of data signals in the optical range, i.e. without opto-electrical and electro-optical conversion of data signals, are particularly significant in this respect.

Transparent optical transmission systems are constructed of several optical network nodes interconnected by means of optical transmission links. Optical transmission channels, particularly optical wavelength channels, are provided for the transmission of optical data signals, particularly optical WDM signals. One of the requirements of operators of such transparent optical transmission systems is an increase in the ability to adapt to the dynamically changing volume of traffic or traffic requirements. Switching matrices that enable flexible switching of the optical data streams or optical data signals on the basis of individual wavelengths are provided in the optical network nodes. This is known as dynamic wavelength routing. By automating this optical channel layer, i.e. by providing an automatically switched transport network (ASTN), the restoration times and the connection establishment times in the event of a fault are substantially reduced.

The optical network nodes provided in such ASTNs are connected to each other mainly via optical transmission links, particularly WDM transmission links. If no wave conversion devices are provided in the individual optical network nodes, it is necessary, in order to establish an optical connection path between a first network node and a second network node connected to it, for example, via several further optical network nodes, to provide in each case the same optical transmission channel, particularly wavelength channel, on the individual optical transmission links. In the case of bi-directional connection paths, the provision of optical transmission channels available in pairs is necessary.

A transparent optical transmission system of this kind enables optical connections to be established between two users, with each optical connection being provided by a selected connection path through the transparent optical transmission system and a specified optical transmission channel.

To establish a new optical connection it is thus necessary to first determine an optical connection path and an optical transmission channel, for example wavelength channel, available on same. In the industry, this problem is known as the dynamic RWA (routing and wavelength assignment) problem. There is also a static RWA problem where all the connection requirement demands are already simultaneously known—cf. Zang et al “Dynamic Lightpath Establishment in Wavelength-Routed WDM Networks”, IEEE Communication Magazine, September 2001, Pages 100 to 108.

When a connection is established, the relevant wavelength channels are occupied on all transmission links of the complete connection path and are thus not available for the establishment of further connection paths.

To solve the dynamic RWA problem, it is necessary to know the occupancy of the wavelength channels within the transparent optical transmission system, so that later when processing a connection requirement a connection path that still has free wavelength channels can be determined. The a-priori knowledge of the network load of the transparent optical transmission system should in this case be as comprehensive as possible, in order to enable the dynamic RWA problem to be solved as well and as quickly as possible and to thus almost completely avoid unsuccessful attempts at establishing connections. The determination of the network load is of decisive importance for this. When considering this further, it is assumed that the connection requirements are not processed by a central network management unit but are instead processed locally, i.e. for example in a first network node. With local processing, the occupancy of the transmission channels on the transmission links of the complete optical transmission system is not, in contrast to central processing, fully known.

To determine and evaluate network load information of this kind, different methods have already been proposed in some publications. These are briefly: Zang et al “Dynamic Lightpath Establishments in Wavelength-Routed WDM Networks”, IEEE Communication Magazine, September 2001, Pages 100 to 108 and Li et al. “Control Plans for Design for Reliable Optical Network”, IEEE Communications Magazine, February 2002, pages 90 to 96.

Locally Available Occupancy Information

The occupancy status of the individual wavelength channels on the local WDM transmission links in this case is known at every timepoint, and a local transmission link is understood to be a transmission link that is connected directly to the individual network nodes. Furthermore, the occupancy state of some non-local wavelength channels is known, i.e. those wavelength channels that are used by connections in which particular network nodes are involved. The disadvantage is that in this way the occupancy of only a small part of all individual wavelength channels within the complete transmission system is known. In particularly there is no information available on those non-local wavelength channels that, for example, are not occupied.

Occupancy of All Wavelength Channels

The occupancy of all wavelength channels can be determined by a routing protocol spread over the complete network. However, with this approach the latest available information is frequently not current, i.e. is incorrect. This is due particularly to the time requirement for updating the network load information used. Furthermore, changes in the occupancy status of the individual wavelength channels can occur very frequently, so that a continuous updating of such occupancy status information can be associated with a high expenditure of resources (transmitting and computing capacity). Up to now, this high expenditure has borne no relationship to the benefit achieved.

Knowledge of the Occupancy of the Wavelength Channels Along One or More Potential Connection Paths

If a potential connection path is first determined by a first network node for a connection requirement, then free wavelength channels for this path can be determined with the aid of signaling messages, and particularly reserved for this communication requirement at the same time. The disadvantage of this is that only a small amount of network load information for selection of the connection path is available to the first network node initiating the connection setup. The danger therefore exists that the selection will be unsatisfactory or that no common wavelength channel will be available for the selected connection path, with the result that a further setup has to be carried out via a different connection path or the connection request has to be refused.

As an alternative to this, by means of the first network node the detailed occupancy state for establishing a connection initially for several potential connection paths can be determined by requesting the participating network nodes, in order to then select the most suitable connection path. In doing so, a restriction to the particular first k transmission links of the different connection paths can take place. A disadvantage of this is that there is an additional expense for determining the occupancy status and the occupancy status information obtained in this way cannot be used for other connection requests.

Central Assignment of Available Bandwidths

By means of a routing protocol, the transmission bandwidths available throughout the network on all the transmission links is assigned by a central control unit. Updating in this case is useful only if specified threshold values are overshot or undershot. Clearly, this information is of only limited use for solving the dynamic RWA problem because it provides no information on wavelength channels.

The object of the invention is particularly to provide a method for determining the network load in a transparent optical transmission system that is an improvement on the disclosed prior art, whereby the network load information can be determined throughout the network and without a high signaling cost.

The object is achieved by the Claims.

The essential advantage of the invention can be seen in that an occupancy probability is determined in the network nodes for each transmission link and each optical transmission channel. The routing decisions can be particularly advantageously improved by means of these determined occupancy probabilities. Furthermore, this enables the current network load to be determined and the future network load to be estimated at a given timepoint as regards the individual optical transmission channels, i.e. particularly the wavelength channels, within a network node without using additional resources.

A further advantage of the invention is that the occupancy probability of an optical transmission channel in the particular network nodes is determined using locally available occupancy status information and/or occupancy status information determined from other network nodes. Furthermore, the occupancy status information for the local transmission channels determined in the particular network nodes is transmitted to the other optical network nodes with the aid of signaling messages and/or routing messages carried via the optical network nodes. The individual network nodes can thus allow this existing network-wide information to be considered as part of the routing decision. This substantially reduces the faulty setup of connection paths.

The occupancy status of local existing optical transmission channels and the associated determination timepoint are advantageously acquired as occupancy status information. In this way, the current network load information for all the optical transmission channels of the transparent optical transmission system is stored in the individual network nodes in the following form:
“Transmission channel x was unoccupied/occupied at time t”.

Further advantageous embodiments of the invention are given in the dependent claims.

Examples of embodiments of the method in accordance with the invention are explained in more detail in the following with the aid of the accompanying drawings.

### BRIEF DESCRIPTION OF THE DRAWINGS

FIG. 1 shows an example of a schematic representation of a transparent optical transmission system in accordance with an exemplary embodiment of the invention,

FIG. 2a shows a schematic representation of the structure of a simple optical waveguide network to explain the principle of the “link state” protocol,

FIG. 2b shows a schematic representation of the structure of the optical waveguide network, shown in FIG. 2a, after a fault has occurred, and

FIG. 3 shows a schematic representation of a comparison between the actual occupancy status of an optical waveguide network with the information on the occupancy status of the optical waveguide network present in network node A, using the method in accordance with the invention.

### DETAILED DESCRIPTION OF INVENTION

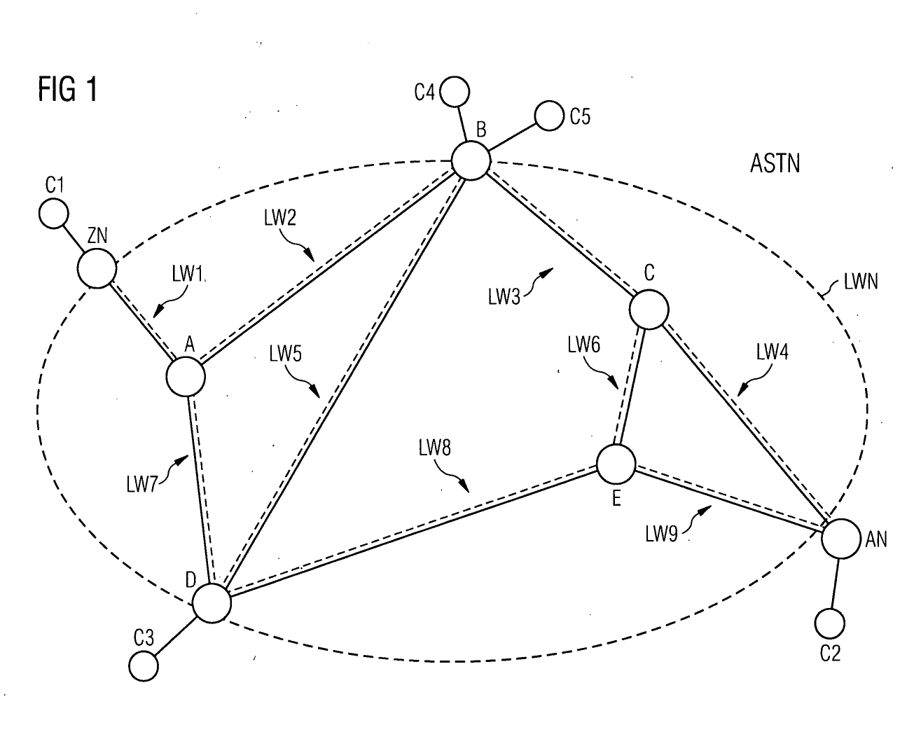

FIG. 1 shows the transparent optical transmission system ASTN (automatically switched transport network) in accordance with a first exemplary embodiment of the invention. This has a number of transit network nodes A, B, C, D, E, ZN, AN connected to each other via an optical waveguide network LWN (shown in FIG. 1 by a dotted line), as well as a number of user terminal devices, particularly client devices C1, C2, C3, C4, C5. These can, for example, be other SDH (synchronous digital hierarchy), ATM (asynchronous transfer mode) or IP (Internet Protocol) client devices, e.g. IP routers. The transit nodes ZN, AN connected to the first and second user terminal devices C1, C2 represent an access network node ZN and output network node AN for the establishment of a connection from the first to the second subscriber terminal devices C1, C2. In this way, for example, the signaling required to establish a connection path is initiated by the network node functioning as an access network node ZN.

Within the optical waveguide network SWN, each network node ZN, AN, A, B, C, D, E is connected by one or more optical waveguide bundles LW or one or more single optical waveguides LW1 to LW9 in each case to one or more other network nodes ZN, AN, A, B, C , D, E.

For data transmission within the optical waveguide network LWN or the transparent optical transmission system ASTN, a WDM (wavelength division multiplex) method can be used. Using the wavelength multiplex technology, several different pulsed optical binary signals can be transmitted simultaneously via each optical waveguide LW1 to LW9 present in the transparent optical transmission system ASTN, by using different wavelength ranges in each case.

Between the particular network nodes ZN, AN, A, B, C, D, E, a first optical transmission channel, preferably a wavelength channel, is used in each case for the transmission of useful signals (shown in FIG. 1 by solid lines), and a second transmission channel, preferably a wavelength channel, provided in each case for transmission of control messages, particularly signaling signals or routing messages (shown in FIG. 1 by a dotted line).

The actual user data in the useful signals and the signaling information in the signaling signals is transmitted in coded form. In this exemplary embodiment, the actual user data and signaling information is transmitted on one and the same optical waveguide LW via different optical transmission channels (e.g. by means of wavelength division and/or time division multiplexing of data channels and signaling channels separated from each other). In alternative exemplary embodiments, the signaling information and the user data is, in contrast, transmitted via separate optical waveguides and/or separate connection paths. The transmission of signaling information via a separate network, e.g. an electrical transmission network, is also conceivable.

With this exemplary embodiment, a link state protocol is, for example, used in order to exchange network load information between the network nodes ZN, AN, A, B, C, D, E.

Link state protocols are based on a decentralized network map. Each of the network nodes ZN, AN, A, B, C, D, E has a storage device (not illustrated) in which a data record representing the complete (topological) map and structure of the optical waveguide network LWN is stored. Information on the occupancy status of individual wavelength channels on the individual transmission links 1, 2, 3, 4, 5, 6 are, for example, part of this data record.

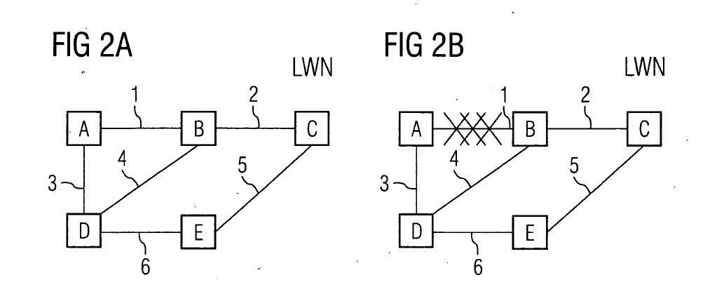

The principle of link state protocols is explained in the following with the aid of a simple optical waveguide network LWN shown in FIG. 2a and FIG. 2b. This, for example, has five network nodes A, B, C, D, E connected to each other by six transmission links 1, 2, 3, 4, 5, 6.

The structure of the data network DNW can be represented by table 1, for example, by the following data record stored in all network nodes A, B, C, D, E:

TABLE 1

| Q | R | S | T |
|---|---|---|---|
| Connection from | Connection to | Connection | State |
| A | B | 1 | 1 |
| A | D | 3 | 1 |
| B | A | 1 | 1 |
| B | C | 2 | 1 |
| B | D | 4 | 1 |
| C | B | 2 | 1 |
| C | E | 5 | 1 |
| D | A | 3 | 1 |
| D | E | 6 | 1 |
| D | B | 4 | 1 |
| E | C | 5 | 1 |
| E | D | 6 | 1 |

In this case, the first variable Q (connection from:) is the identifier of the network node from which the particular transmission link leads, the second variable R (connection to:) is the identifier of the network node to which the particular transmission link leads, and the third variable S (connection) is the identifier of the particular transmission link. The fourth variable T (status) represents the occupancy status of the particular transmission link.

An occupied transmission link can be identified by the value “1”, e.g., with the aid of a status variable T. (see the fourth column of the above table 1). If the transmission link is not occupied, the state variable T is accordingly adapted (e.g. from the value “1” to the value “0” or “∞”).

Because the complete network topology is known to each network node A, B, C, D, E, each node can itself calculate the transmission channel or wavelength channel, that is not occupied or is most favorable, to any other network node A, B, C, D, E.

FIG. 2b is a schematic representation of the structure of the optical waveguide network LWN shown in FIG. 2a after a change to the network topology (in this case an interruption on the transmission link 1 between network node A and network node B). The change in the status of the relevant transmission link 1 is identified by network node A and network node B. Network node A and network node B each update the data record stored in them and transmits the updated data record to the other network nodes C, D, E. Something called a flooding protocol is used for this purpose. In one exemplary embodiment of the invention, the occupancy status of the optical transmission channels, i.e. particularly the wavelength channels on the transmission links 1, 2, 3, 4, 5, 6 connected to the optical network nodes is acquired in each optical network node A, B, C, D, E and transmitted, together with the particular detection timepoint tₒ, to the other optical network nodes A, B, C, D, E, with the aid of the signaling messages transmitted via the optical network nodes A, B, C, D, E. This occupancy status information is stored in the data record in the individual network nodes A, B, C, D, E.

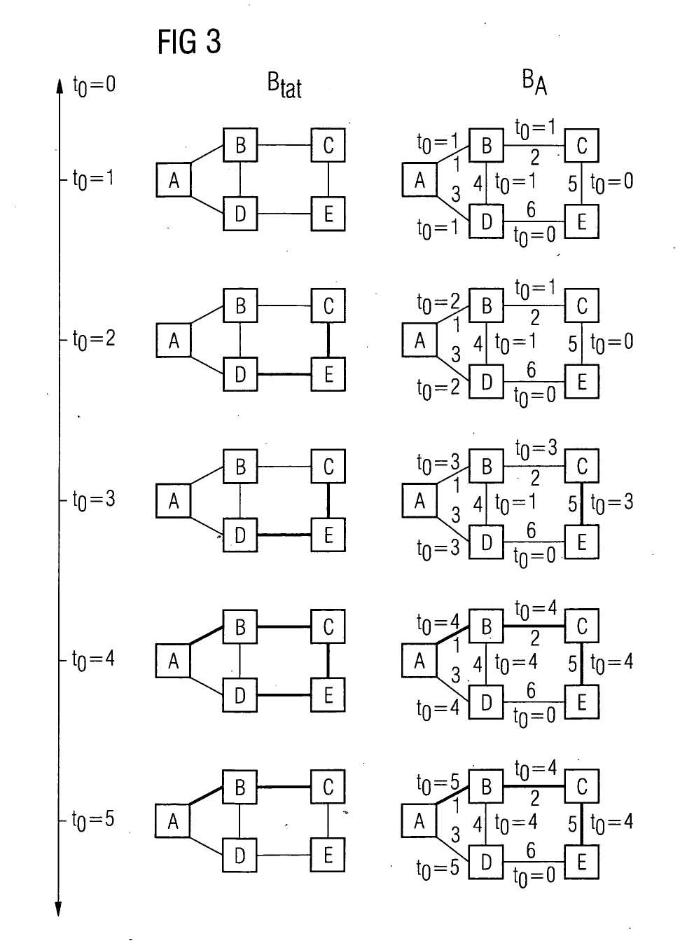

FIG. 3 is a schematic representation of an example of a comparison of the actual occupancy status Bₜₐₜ of an optical waveguide network LWN with the information on the occupancy status BA of the data network DNW present in a network node A. In other words, the network load from the point of view of the network node A is compared with the actual network load of the complete optical waveguide network LWN. For reasons of clarity, this case considers only the occupancy status of one optical transmission channel, i.e. in particular for a single wavelength. The occupancy status of the optical waveguide network LWN in this case is shown at five different timepoints tₒ=1 to tₒ=5, whereby in the illustrations of the optical wavelength network LWN, representing the point of view of network node A, the detection timepoint tₒ of the occupancy status information is shown for each of the six transmission links 1, 2, 3, 4, 5, 6.

At timepoint tₒ=0, the illustrated optical waveguide network LWN is put into operation, i.e. all the available wavelength channels are still unoccupied (all transmission links 1, 2, 3, 4, 5, 6 are shown in FIG. 3 as thin lines). Then by timepoint tₒ=1 the existing occupancy states of the transmission channels on the transmission links 1, 2, 3, 4, 5, 6 throughout the network are made known, for example using routing messages. Because no connection paths have as yet been set up, all the occupancy states of the transmission channels under consideration are correctly acquired on transmission links 1, 2, 3, 4, 5, 6.

At timepoint tₒ=2, an optical connection path, within the optical waveguide network LWN, between network nodes D-E-C is established and maintained. The occupancy of the wavelength channel on the fifth and sixth transmission links 5, 6, required for this optical connection path, is shown in FIG. 3 by thick lines. Because network node A is not part of the connection path D-E-C and thus the signaling messages are not carried via network node A, no updating of the network load information in network node A, affecting the fifth and sixth transmission links 5, 6, takes place. Therefore, no network load information reflecting the changed occupancy state is available in network node A at timepoint tₒ=2. The network load information for the fifth and sixth transmission links 5, 6 stored in the data record therefore continue to show the state at detection timepoint tₒ=0. In contrast, the occupancy status of the two local transmission links 1, 3 is known at all times, i.e. their detection timepoint tₒ is thus tₒ=2.

At timepoint tₒ=3 the occupancy status of the information referring to the transmission links 2, 5 connected to network node C is transmitted by means of a routing message to the other network nodes, particularly network node A. The network node information stored in network node A is updated. The occupancy status B_{A} from the point of view of network node A shows a distinctly greater agreement with the actual occupancy state Bₜₐₜ due to the proposed method for determining the network load at timepoint tₒ=3. All the network load information present in network node A is updated except for the individual transmission links 4, 6.

Furthermore, at timepoint tₒ=4 a connection path is established between network nodes A-B-C. Because network node A is part of the connection path, all current occupancy status information is transmitted to it by means of the signaling messages. These are evaluated in network mode A to update the data record. After this evaluation, the occupancy state B_{A} from the point of view of network node A at timepoint tₒ=4, shown in FIG. 3, results. The viewpoint of network node A agrees with the actual occupancy status Bₜₐₜ except for transmission link 6. In this way, a distinct improvement of the network load information in the individual network nodes is achieved with practically no additional resource expenditure, due to the proposed distribution of the occupancy status information using signaling messages and/or routing messages.

The connection path D-E-C is disconnected again at timepoint tₒ=5. This disconnection is not however perceived from the point of view of network node A because of the absence of participation by network node A in the connection path. Therefore, from the point of view of network A the wavelength channel carried via transmission link 5 continues to be occupied. This is shown in turn by detection timepoint tₒ=4 assigned in the drawing to transmission link 5 and by the thick line.

The layout of the transmitted data record can, as a static property of the node, be distributed throughout the network by routing messages. For example only one bit is required in each case per transmission link and wavelength channel for the transmission of this local occupancy status information. Furthermore, updating of this data record is then necessary only if a connection is established or disconnected with the participation of the network node A, B, C, D, E under consideration.

The basis of the proposed method for determining the network load is the calculation of the uncertainty regarding the present occupancy of a wavelength channel using an occupancy probability. Thus, a distinction is made not only between free (OFF) and occupied (ON), but furthermore an occupancy probability
P_{ON}(t)=P{Channel is occupied at time t}
that can be determined for future timepoints t is introduced. The time change of this occupancy probability can be estimated by evaluating the user behavior. The routing decisions can be significantly improved by means of these occupancy probabilities p_{ON} (t). If the occupancy status of a wavelength channel is known, then, for example, we get the following probability values:
p_{ON}(t)=1 (wavelength channel is occupied) or
p_{ON}(t)=0 (wavelength channel is free).

Each individual wavelength channel switches between two states: OFF (free) and ON (occupied), with the change being mainly determined by the user behavior. The free time duration T_{OFF} and the occupancy time duration T_{ON} are two random variables whose distribution function or characteristics such as expected value and variance can be approximately determined by sampling. These are distributed throughout the network by routing messages. Updates are, for example, sent at regular intervals or alternatively in the event of significant changes in the network load.

With the aid of this transmitted information, the occupancy probability P_{ON}(t) for the particular optical transmission channels, particularly the wavelength channels, can be estimated in the individual network nodes A, B, C, D, E.

Without occupancy status information present in the network nodes, we get the following for the particular occupancy probability of a wavelength channel:

$${p}_{ON} ( ∞ ) = \frac{< {T}_{ON} >}{< {T}_{ON} > + < {T}_{OFF} >} ,$$

where ( . . . ) stands for the expected value of the particular random variables. If, however, the occupancy status at a detection timepoint tₒ is known, an improvement in the estimation for p_{ON}(t) is then possible. The estimation can generally be improved, particularly also additionally improved in this way, in that the information on the duration of the current occupancy status at detection timepoint tₒ is included in the estimation.

A good estimation is therefore also possible if the first random variable, the occupancy time duration T_{ON}, and the second random variable, the free time duration T_{OFF}, are described by the aforementioned characteristics
p_{ON}(∞) (average loading) and
T_{ON} (average occupancy time duration)
   distributed throughout the network.

Each node within the transparent optical transmission system ASTN knows these two characteristics p_{ON}(∞) <T_{ON}> for all wavelength channels. A total mean value for the average occupancy time duration <<T_{ON}>> is formed from the individual mean values for the average occupancy time duration <T_{ON}>. From the total mean value for the average occupancy time duration <<T_{ON}>> and the average load p_{ON}(∞), an occupancy rate K for the individual channels is formed as follows:

$$K = \frac{1}{〈 〈 {T}_{ON} 〉 〉 \cdot ( 1 - {P}_{ON} ( ∞ ) )}$$

This channel-specific occupancy rate K is included when estimating the current occupancy probability p_{ON} (t), as follows:

$${p}_{ON} ( t ) = \{ \begin{matrix}{p}_{ON} ( ∞ ) + ( 1 - {p}_{ON} ( ∞ ) ) \cdot exp ( - κ ( t - {t}_{0} ) ) \\ {p}_{ON} ( ∞ ) - {p}_{ON} ( ∞ ) \cdot exp ( - κ ( t - {t}_{0} ) )\end{matrix} for \{ \begin{matrix}{p}_{ON} ( {t}_{0} ) = 1 \\ {p}_{ON} ( {t}_{0} ) = 0\end{matrix} .$$

With the help of this probability, the occupancy status information, and thus the network load information, is projected, in accordance with the proposed method, from the past into the future. In this way it is possible to use the “past” occupancy of wavelength channels for future routing decisions. The additional routing traffic necessary for this is relatively small because only two slow-changing characteristics (the average load p_{ON}(∞) and the average occupancy time duration <T_{ON}>) have to be distributed throughout the network. Compared with the approach where all the occupancy status changes are distributed throughout the network, the proposed method substantially reduces the resource expenditure while at the same time improving the knowledge of the network load.

In this way, the occupancy of any wavelength channel is determined using an occupancy probability p_{ON}(t) or is estimated for a timepoint tₒ. The occupancy probability p_{ON}(t) per optical transmission channel is exact, assuming that the occupancy time duration and free time duration random variables are exponentially distributed and each of the optical transmission channels, particularly wavelength channels, under consideration are independent of each other. The approach used here has the advantage that because the exponential distribution is memory-free only the occupancy status at timepoint tₒ, but not that of the earlier timepoints, has to be considered.

Furthermore, the proposed method can be further expanded in that not only the average load p_{ON}(∞) and average occupancy time duration <T_{ON}> for all optical transmission channels, but also the correlation between the occupancy states of the optical transmission channels within a network node, can be determined, distributed and evaluated. A correlation exists in particular if other connection paths are set up via the network node under consideration.

The quality of the estimation can particularly be improved in that in fact all previous occupancy states can be taken into account, but the most recent occupancy states of the particular optical transmission channel can be more heavily weighted.

The method presented here for determining the network load within a transparent optical transmission system ASTN can be used when establishing both directed and undirected (bi-directional) optical connection paths.

1.-9. (canceled)

10. A method for determining a network load in a transparent optical transmission system having a number of network nodes connected to each other via optical transmission links, wherein several optical connection paths are established, maintained and disconnected from a first optical network node to a second optical network node by means of signaling messages via at least one transmission link having optical transmission channels, the method comprising:
determining an occupancy probability for each optical transmission channel in the network nodes for each transmission link.

11. The method in accordance with claim 10, wherein in a network node the occupancy probability of an optical transmission channel is determined using locally available network load information and/or network load information transmitted from other network nodes.

12. The method in accordance with claim 10, wherein in each optical network node the network load information for locally available optical transmission channels is determined and transmitted to the other optical network nodes using the signaling messages and/or routing messages carried via these optical network nodes.

13. The method in accordance with claim 11, wherein in each optical network node the network load information for locally available optical transmission channels is determined and transmitted to the other optical network nodes using the signaling messages and/or routing messages carried via these optical network nodes.

14. The method in accordance with claim 11, wherein an occupancy state of the locally available optical transmission channels and an associated detection point of time are acquired as network load information.

15. The method in accordance with claim 12, wherein an occupancy state of the locally available optical transmission channels and an associated detection point of time are acquired as network load information.

16. The method in accordance with claim 13, wherein an occupancy state of the locally available optical transmission channels and an associated detection point of time are acquired as network load information.

17. The method in accordance with claim 12, wherein the locally available optical transmission channels of an optical network node lie on the transmission links connected to the network nodes under consideration.

18. The method in accordance with claim 14, wherein the locally available optical transmission channels of an optical network node lie on the transmission links connected to the network nodes under consideration.

19. The method in accordance with one of claim 12, wherein characteristics of the occupancy time duration, evaluated as a first random variable, and an idle time duration, evaluated as a second random variable, of each locally available optical transmission channel in the relevant network nodes are determined as network load information.

20. The method in accordance with one of claim 14, wherein characteristics of the occupancy time duration, evaluated as a first random variable, and an idle time duration, evaluated as a second random variable, of each locally available optical transmission channel in the relevant network nodes are determined as network load information.

21. The method in accordance with one of claim 17, wherein characteristics of the occupancy time duration, evaluated as a first random variable, and an idle time duration, evaluated as a second random variable, of each locally available optical transmission channel in the relevant network nodes are determined as network load information.

22. The method in accordance with claim 19, wherein the expected value of the first random variable and the average occupancy probability are determined as first and second characteristics.

23. The method in accordance with claim 20, wherein the expected value of the first random variable and the average occupancy probability are determined as first and second characteristics.

24. The method in accordance with claim 22, wherein a channel-specific occupancy rate, that is evaluated for the estimation of the future occupancy probability of an optical transmission channel is determined from the first and second characteristics of an optical transmission channel.

25. The method in accordance with claim 23, wherein a channel-specific occupancy rate, that is evaluated for the estimation of the future occupancy probability of an optical transmission channel is determined from the first and second characteristics of an optical transmission channel.

26. The method in accordance with claim 10, wherein occupancy probabilities per transmission channel are taken into account when establishing optical connection paths within the transparent optical transmission system.

27. The method in accordance with claim 11, wherein occupancy probabilities per transmission channel are taken into account when establishing optical connection paths within the transparent optical transmission system.
